(19) United States
(12) Patent Application Publication
(10) Pub. No.: US 2005/0189813 A1
(43) Pub. Date: Sep. 1, 2005

(54) Wheel with tubeless tire

(75) Inventor: Andreas Beat Bauer, Ebmatingen (CH)

Correspondence Address: GREER, BURNS & CRAIN, LTD., Suite 2500, 300 South Wacker Drive, Chicago, IL, 60606, US

(73) Assignee: DT Swiss Inc.

(21) Appl. No.: 11/042,827

(22) Filed: Jan. 25, 2005

(30) Foreign Application Priority Data
Jan. 26, 2004 (DE) 10 2004 003 873.2

(51) Int. Cl. B60B 21/00

(52) U.S. Cl. 301/95.104

(57) ABSTRACT

A wheel for a bicycle including a rim body suitable for receiving a tubeless tire, a valve for inflating the tire with air, at least one first sealing device positioned on the rim body for sealing at least one aperture provided in the rim and a sealing medium for sealing leakages, wherein the valve has at least one second sealing device for sealing the valve relative to the rim.

The invention relates to a wheel with a tubeless tire. Although the invention is described with reference to the wheel of a bicycle, it should be noted that the invention can as well be used with other wheels such as mopeds, tricycles or the like.

Such wheels with tubeless tires are known from the prior art. There are also known special wheels or rims which are used to prevent loss of air from the tire, in particular during operation of the bicycle. The rims known from the prior art have as a rule a number of apertures for the valve and for mounting spokes. For this reason there is the problem to prevent air from escaping through said apertures.

It has been known in the prior art to use sealing tape which covers said apertures and can be stuck onto the rim. These solutions generally work satisfactorily. However—in particular with high load applied to the wheel—loss of air can still occur with this type of sealing.

It is therefore the object of the present invention to improve sealing in the rim for the use of tubeless tires. According to the invention this is achieved by the objects of the independent claims. Preferred embodiments and further developments are the objects of the subclaims.

A wheel for a bicycle according to the invention comprises, a rim body suitable for receiving a tubeless tire, a valve for inflating the tire with air, at least one first sealing means positioned at least on one portion of the rim body for sealing at least one aperture provided in the rim and a sealing medium for sealing leakages, wherein the valve comprises at least one second sealing means to seal off the valve relative to the rim.

A sealing means is understood to mean any means which seals off two spaces from one another such as the interior of a tire from the exterior of the tire.

Preferably the rim body comprises at least one side facing the tire or one surface facing the tire and at least one side facing away from the tire or one surface facing away from the tire.

In a preferred embodiment the first sealing means is a rim tape positioned at the rim body. The sealing means is preferably positioned on the side of the rim body facing the tire.

In another preferred embodiment the first sealing means is made of a material containing TPU (thermoplastic polyurethane). Preferably said first sealing means is substantially made of TPU. The advantage of this material over for example rubber is higher strength or toughness. In addition, TPU has higher resistance to abrasion than rubber.

Manufacturing from TPU offers the additional advantage that a particularly high-quality, fine butt-weld joint can be obtained.

Preferably the first sealing means is applied to the rim body in a pre-stressed state. It is particularly preferred to stretch the first sealing means by 2 to 50%, preferably by 5 to 40% and particularly preferred by 10 to 30%. In this way a very precise and better positioning of the first sealing means relative to the rim body can be achieved and moreover the prestress permits better centering during mounting and higher contact pressure.

In another preferred embodiment the first sealing means comprises at least one aperture. Said aperture serves to pass the valve through. The aperture is preferably made during manufacture by punching.

In another preferred embodiment the punched hole is positioned opposite the butt weld, meaning in the rim tape that is arranged around the rim body substantially in a circle, the aperture is at a maximum distance from the place where the beginning and the end of the rim tape are fused together. In this way the weld seam is loaded with the lowest possible stress.

Preferably the aperture has a cross-section adapted to the valve cross-section so as to achieve a force fit with the valve. In a preferred embodiment the hole has a diameter of 1 mm to 10 mm, preferably between 2 mm and 8 mm and particularly preferred of approximately 4 mm. However, it is also possible to provide the hole with other cross-sections such as ovoid, ellipsoid, polygonal and the like. The aperture may preferably be punched with an ovoid or ellipsoid cross-section so as to receive a substantially circular shape due to the influence of the prestress on the rim body. The long diameter of said elliptical cross-section before mounting the rim tape to the rim body is substantially perpendicular to the rim body, i.e. perpendicular to the plane of the wheel.

In another preferred embodiment the first sealing means comprises at least one surface with adhesive properties. The first sealing means may directly comprise an adhesive, i.e. adhesive layer or it may be joined with another means such as an adhesive tape. In this case the adhesive tape and the rim tape positioned at the rim body are considered to be the common first sealing means. Preferably the rim tape positioned at the rim body comprises at least one surface portion having a structure. Structure is understood to mean for example ribbing or the like. Said structure serves to increase the cohesive friction with the adhesive tape.

Furthermore the sealing means may comprise further structurized surfaces so as to increase for example the cohesive friction with the tire.

In another preferred embodiment the adhesive tape comprises an adhesive containing acrylate. It is particularly preferred that the adhesive is substantially made of acrylate. The advantage of said material is that it is substantially not impaired by solvents or ammonia.

Preferably a polyester foil is provided for the adhesive tape—in particular as a component of the sealing means—onto which the adhesive is preferably applied. The advantage of selecting this material is high strength which in turn has the advantage of facilitating mounting and in this way one can achieve a preferably high-quality sealing of the interior of the tire relative to the holes arranged in the rim which are provided for example for receiving spoke nipples which in turn serve to attach the spokes. The adhesive tape is preferably transparent which facilitates mounting.

When applying the adhesive tape, the adhesive tape is preferably positioned in the region of the valve such that the beginning and the end overlap. In this way improved sealing can be achieved since a reduced action surface is generated for the compressed air in the interior of the tubeless tire and in the region of the valve aperture.

Preferably the adhesive tape is provided with an aperture having a smaller cross-section than the corresponding aperture in the rim wall. Choosing this smaller cross-section can improve sealing in the region of the valve. The aperture in the adhesive tape can for example be made by means of a preferably pointed object.

The materials polyester and acrylate mentioned above are substantially stable at temperatures up to 175 degrees Celsius. This thermal stability is necessary for rim braking with V-brakes.

In another preferred embodiment the adhesive tape is placed on a cardboard carrier having a predetermined thickness so as to obtain a higher mounting tension. The diameter of said cardboard carrier is larger than 30 mm, preferably larger than 50 mm and particularly preferred larger than 70 mm.

The adhesive is applied on both sides relative to the adhesive tape so as to ensure adhesion to the rim on one side and to the rim tape on the other side. Preferably the adhesive is applied at a thickness of between 0.04 mm and 0.12 mm, preferred between 0.06 mm and 0.1 mm and particularly preferred in the range of approximately 0.08 mm. Such application can achieve a particularly advantageous ratio of the adhesive force on the one hand and elasticity at the rim on the other hand.

Preferably the adhesive tape comprises a smoothly gliding protecting foil. In this way the adhesive tape can be stuck on under high pressure and moreover the protecting foil can be removed in a particularly advantageous way from the adhesive tape containing polyester and/or acrylate.

In another preferred embodiment the valve is a multipart structure. This embodiment serves to achieve that not only air can be fed into the tire through the valve but the sealing medium can also be filled in through the valve. The valve preferably comprises a removable valve insert, particularly preferred one that unscrews. To improve ease of feeding in the sealing medium, the valve is preferably nickel-plated.

In a preferred embodiment the second sealing means is made of a flexible material. Preferably the second sealing means is a sealing lip of flexible material, such as rubber or plastic, that fits snugly on the rim bodies. In a preferred embodiment the second sealing means is a rubber component having a predetermined cross-section such as a rectangular rubber component. Said rubber component is particularly preferably cone-shaped such as to improve attachment in specific rim profiles such as UST rim profiles.

Preferably a second sealing means, which is a substantially round rubber component, can be used to improve the force fit with the rim tape and thus the leak-tightness or attachment, respectively. Preferably the valve has an internal valve thread at a predetermined cross-section attached such as to allow a valve extension to be screwed on wherein for example a 3/16″ internal valve thread may be chosen. The interior bore of the valve has a diameter between 1 mm and 8 mm, preferably between 2 mm and 6 mm and particularly preferred in the range of 4 mm such that the sealing medium can readily pass into the interior of the tire system.

Another preferred embodiment comprises a second sealing means with an enlarged surface such as a surface of 12×8 mm which assists in that the valve cannot be torn out even from a rim bore in the range of 8 mm.

The Shore hardness of the rubber is preferably configured such as to provide spring properties and the knurled nut of the valve cannot loosen. Said knurled nut preferably comprises on two sides two cylindrical steps at predetermined diameters, particularly preferred 8 mm×1.5 mm so as to be used directly as an attachment in a rim with an 8 mm bore. The respective diameters can, however, deviate from the indicated sizes, depending on the used rim or its apertures.

In another preferred embodiment, a closure means is provided as the first sealing means for the at least one aperture in the rim body, preferably for substantially every aperture in the rim body. The closure means may be used in addition to or instead of the rim tape.

Said closure means may in particular but not exclusively be a sealing plug which substantially seals the aperture. Said sealing plug may comprise an end portion having a cross-section larger than the aperture. Preferably the sealing plug comprises two end portions both of which have a cross-section enlarged relative to the aperture in the rim body and between which the aperture or the circumferential edge of the aperture can be received.

In another preferred embodiment the second sealing means is positioned at a shaft of the valve. Particularly preferred the sealing means is positioned at the shaft of the valve to be tight so as to substantially prohibit air from escaping at the location of the valve at the rim body.

Preferably the second sealing means is positioned at a predetermined end portion of the valve.

It is particularly preferred that the second sealing means comprises a substantially planar foil or is formed of a substantially planar foil.

Preferably the sealing means contains components selected from a group of components including water, rubber latex, antifreeze agents and emulsifiers. The sealing medium is preferably a liquid substance whose carrier liquid is in particular water. The antifreeze agents and the emulsifiers are preferably components containing propylene glycol wherein said component ensures improved compatibility and wetting of the tire.

Preferably the sealing medium contains latex such that durable sealing of leakages can be ensured. Preferably the sealing medium contains more than 40%, particularly preferred more than 50% and in particular more than 60% latex. This composition results in that dried out residue can be removed easily, for example by rubbing.

Further the sealing medium exhibits a viscosity of 0.01 Pas to 0.40 Pas, measured at a temperature of 23 degrees Celsius in the measuring system according to ISO 3219 at a shear rate of D=400 l/sec. This viscosity serves for the liquid to disperse evenly and to remain in motion so as to immediately seal even the tiniest leakages.

Further the sealing medium comprises a content of dry solid matter of more than 30%, preferably more than 45% and particularly preferably more than 50%. Choosing this content serves to achieve durable sealing on the one hand and to ensure on the other hand an even or uniform distribution of the sealing medium in the tire system.

Preferably the sealing medium is stored in a container made of soft PE wherein the container—in particular but not exclusively—is a bottle which can be discharged manually. The container comprises a dispenser means which—in particular but not exclusively—is a feeding nib formed such that it fits into the valve substantially without play. Preferably the dispenser means, i.e. the feeding nib, has a tip to be removed for first use, removable for example by cutting off. In this way the sealing medium can be fed into the device or the interior of the tire.

In addition the container comprises a turning-closure to ensure multiple turns of the sealing medium. The transition between the dispenser means of the container and the container itself comprises a force fit so as to achieve an optimum retaining force between the bottle and the dispenser means while still allowing machine filling of the container.

During filling, a constant pH value of the sealing medium is preferably ensured. It is particularly preferred that both the container and the dispenser means are dyed such as to render them particularly suitable for long-term storage. This can be ensured through substantially prohibiting light incidence into the interior of the container.

The present invention further relates to a sealing device for wheels comprising, at least one first sealing means attachable to a rim body for sealing off at least one aperture provided in the rim, a sealing medium for sealing leakages and at least one second sealing means for sealing off a valve relative to the rim. This means that the sealing device according to the invention may also be subsequently retrofitted to existing rims for tubeless tires.

The present invention further relates to a method of manufacturing a wheel wherein in one step, a rim for the wheel is provided, said rim comprising at least one aperture, in another step at least one first sealing means is applied to the rim, in another step a valve is placed in the rim, and in another step at least one sealing medium for preventing leakages is introduced.

The sealing medium preferably contains rubber latex and other substances. Rubber latex is particularly suitable for sealing leakages. The use of rubber latex offers the advantage that it can be washed out after use of the wheel or after treatment, respectively.

Preferably a second sealing means is positioned at the valve. Said second sealing means serves in particular to seal the valve off relative to the rim body so as to substantially prohibit air from escaping in the region around the valve.

In another preferred embodiment the sealing medium is fed through the valve to the rim or the rim body, respectively.

Preferably a tire is placed on the rim body in another process step.

Preferably the first sealing means is mounted on the rim at a predetermined prestress so as to obtain better positioning of the first sealing means relative to the rim and—as specified above—to ensure increased contact pressure.

Other advantages and embodiments of the present invention can be taken from the accompanying drawings.

These show in:

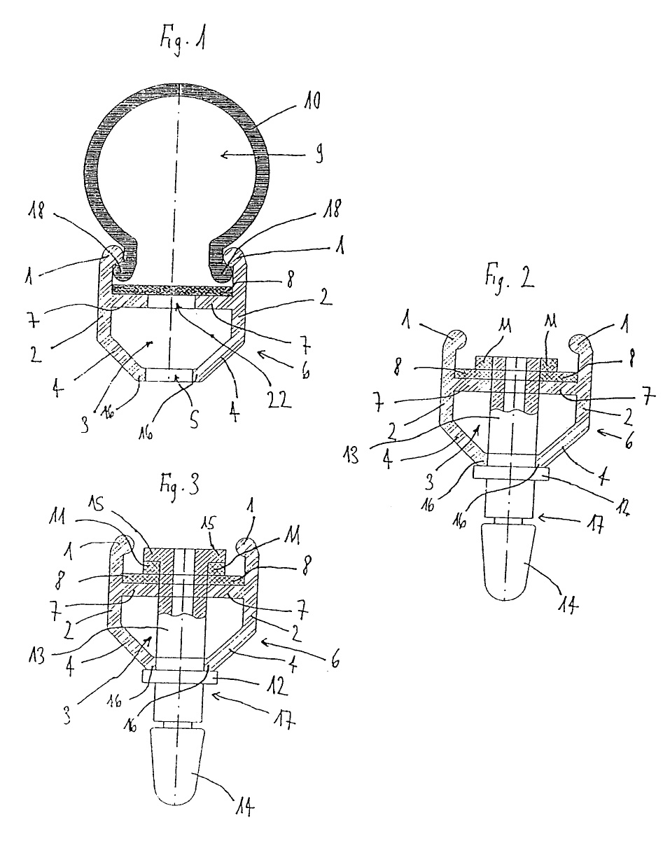

FIG. 1 the cross-section of a rim with a rim tape and a tire mounted to the rim;

FIG. 2 the cross-section of a rim according to FIG. 1 and a valve mounted to the rim;

FIG. 3 an alternative to the embodiment in FIG. 2;

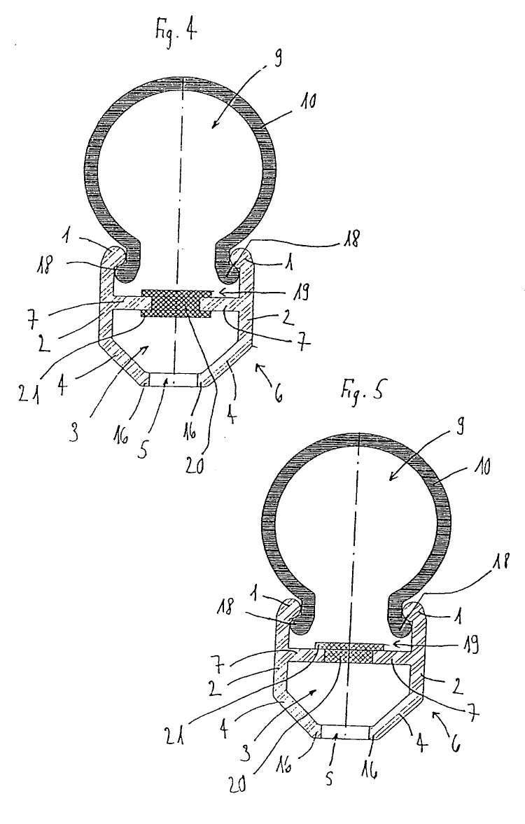

FIG. 4 a rim and a tire according to FIG. 1 with a sealing plug;

FIG. 5 an alternative to the embodiment in FIG. 4; and

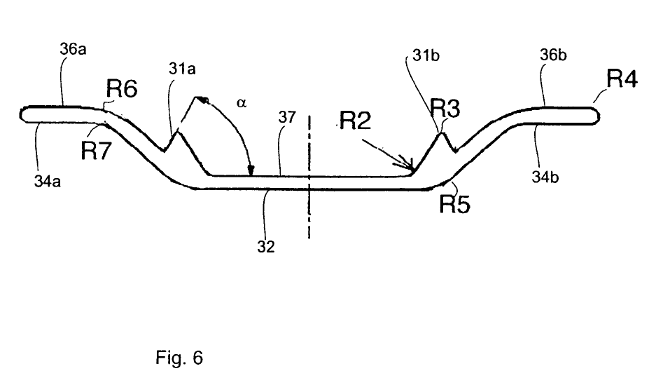

FIG. 6 a representation of the rim tape according to the invention.

The invention will first be illustrated in an example based on FIGS. 1 and 2.

FIG. 1 shows the cross-section of a rim 6 with tire 10 mounted. The rim 6, substantially U-shaped in this embodiment, is formed of two side walls 2 substantially parallel to one another, two angled walls 4 which are at an obtuse angle relative to the side walls 2 extend toward one another in the direction of the geometric center of the rim and have segments 16 at their ends which are substantially rectangular relative to the side walls 2.

One crosswall 7 each is attached to the insides of and at right angles to the two side walls 2. The crosswalls 7 and the segments 16 of the angled walls 4 each define one of the apertures 5 and 22 through which a valve 17 can be retained. Similar apertures can be located in the rim 6 for attaching the screw nipples of spokes (not illustrated in the FIGS. 1 to 3). Preferably the apertures for the screw nipples have smaller cross-sections than the apertures for the valve. The crosswalls 7 and the side walls 2 and the angled walls 4 combined form rim interior 3.

On the tire side the side walls 2 comprise one rim flange 1 each wherein one nose 18 of the tire 10 engages with the rim flange 1 of the rim 6 such that the rim flange 1 and the nose 18 establish a force-closed connection with one another.

On the tire side surface of the crosswalls 7 a closure means is placed at the crosswalls 7 in the form of a self-adhesive, airtight rim tape 8. Said rim tape 8 may be structured in one or two parts and in the latter case—in particular but not exclusively—it may comprise an adhesive tape and a rim tape.

It extends substantially from the one sidewall 2 to the other sidewall 2, delimiting the rim interior 3 from the interior 9 of the tire 10 in conjunction with the crosswalls 7. The rim tape 8 may be placed on the surfaces of the rim interior 3, i.e. in FIG. 1 on the bottom surface of the crosswalls 7. In these cases the rim tape 8 rests on the crosswalls 7 and/or the angled walls 4 so as to close the aperture 5 and/or the aperture 22. The rim tape 8 is preferably fiber-reinforced such that it is not deformed due to the air pressure in the interior 9 of the tire 10 nor forced out of the apertures 5, 22 of the rim 6. Another preferred embodiment provides that instead of mounting one rim tape 8, two or more sealing tapes 8 may be mounted, particularly preferably at least partially overlapping.

The rim 6 illustrated in cross-section according to FIG. 2 comprises a valve 17 mounted to the rim 6. The valve 17 comprises a shaft 13 and a valve head 14 wherein the valve 17 includes a valve mechanism not shown in FIG. 2.

At the head end the shaft 13 comprises a nut 12 and at the tire end of the interior portion of the shaft 13, a second sealing means referred to below as sealing lip 11, said sealing lip 11 preferably resting on the rim tape 8 positioned on the tire side surface of the crosswalls 7.

The sealing lip 11 may be directly placed on the rim 6 if no rim tape 8 is mounted to the crosswalls 7. The interior portion of the shaft 13 designates that portion of the shaft 13 located inside the rim 6.

The sealing lip 11 rests on the rim tape 8 or the rim 6 or it is fastened to the rim 6 or the rim tape 8 by means of—in particular but not exclusively—an adhesive. Additionally the sealing lip 11 is pressed against the rim 6 or the rim tape 8 due to the internal pressure of the tire 10.

The sealing lip 11 is preferably a foil configured such that it rests substantially plane on the rim 6 or the rim tape 8. The sealing lip 11 may also be a rubber component having a predetermined cross-section, or else an additional rubber component may be positioned adjacent to the sealing lip 11. Using such a rubber component can lead to enhanced attachment between the valve and the rim. The tightness can also be enhanced. The rubber component can further be adapted to the rim structure, for example be configured cone-shaped.

In a preferred embodiment the sealing lip fixedly attached to the valve shaft is configured such that it is placed between the projections 31a and 31b (shown in FIG. 6) of the rim tape 8 such that the sealing lip 11 is prohibited from twisting in that the sealing lip abuts against the projections 31a and 31b. In this way it is prevented that the sealing lip is twisted as the valve is twisted wherein the fixed connection of the valve shaft with the sealing lip prohibits the valve from twisting as a whole.

The sealing lip 11 is fixed to the shaft 13 of the valve 17 for example by being vulcanized to it.

Furthermore it is not imperative that the sealing lip 11 is positioned at the end facing the tire of the interior portion of the shaft 13. The sealing lip 11 can be placed anywhere on the interior portion of the shaft 13.

In addition one can use a—preferably flat—washer (not shown) at the sealing lip 11 which ensures the tightness of the transition from the valve 17 to the rim tape 8 even if the valve 17 is slanted relative to the rim 6.

As shown in FIG. 2, the valve 17 is retained in the rim 6 by a nut 12 and the sealing lip 11. It is conceivable, however, to fix the valve 17 for example by casting it integrally with the rim 6.

Furthermore a sealing ring (not shown) may be provided between the nut 12 and the rim 6 which causes a force fit and prevents the rim surface being scratched in particular in case of angular misalignment. In addition said sealing ring can prevent undesirable liquids such as water entering.

FIG. 3 shows in analogy to FIG. 2, a rim 6 with a valve 17. Contrary to FIG. 2 the tire side end of the valve 17 is extended, comprising two walls 15 projecting perpendicular from the shaft 13 of the valve 17. Between these walls 15 and the crosswalls 7 of the rim 6 there are positioned the sealing lip 11 and the rim tape 8. It is also conceivable that in the absence of a rim tape 8 the sealing lip 11 lies only between the perpendicularly projecting walls 15 of the valve 17 and the crosswalls 7 of the rim 6.

The sealing lip 11 is held in position by resting on the rim tape 8 or the crosswalls 7 wherein it presses on the rim tape 8 or the rim 6 through the perpendicularly projecting walls 15 of the valve 17 and is thus fixed.

Another conceivable way of fixing is to attach the sealing lip 11 to the perpendicularly projecting walls 15, to the shaft 13 or the rim tape 8, or to the crosswalls 7. The fixing means is—in particular but not exclusively—an adhesive. In this embodiment, a rubber component may also be positioned adjacent or additionally to the sealing lips 11. As in the above embodiment, the rubber component may be configured large enough so that the valve cannot be torn out even with a rim bore (for example in the range of 8 mm). Suitable dimensions are, 8 mm to 16 mm by 4 mm to 12 mm, preferably about 12 mm by 8 mm.

Preferably the rubber component has such a Shore hardness that it has spring properties and in this way the nut 12 is prevented from loosening.

As mentioned before, a number of apertures 22 may be positioned in the rim 6, one of which serves as a passage for the valve 17 and the others for example for mounting the spokes.

The rim tape 8 serves for sealing said apertures 22 positioned in the rim 6 with the exception of that aperture 22 through which the valve 17 passes. It may, however, be replaced by other suitable closure means.

For this reason the rim tape 8 comprises an aperture at the position of the valve 17 where the valve 17 can be pushed through.

The nut 12 is preferably configured so as to comprise steps or end portions (not shown) which engage with the apertures 5 provided in the rim 6 so as to allow direct attachment.

For screwing and unscrewing the valve 17 a tool is preferably used designed such that it can be used in a spoked wheel.

The valve 17 is preferably provided with a fine-pitch thread (for example M6×0.8 mm) which results in a high tensile and/or holding force.

FIG. 4 shows in analogy to FIG. 1, the cross-section of a rim 6 with a tire 10. Contrary to FIG. 1 the closure means provided here is, instead of a rim tape 8, a sealing plug 19 inserted into the aperture 22 and closing it. The sealing plug 19 comprises a base body 20 with lips 21. The sealing plug 19 is held in the rim 6 in that the lips 21 rest both on the tire side and on the surface of the crosswalls 7 facing away from the tire. In this embodiment the sealing plug 19 is considered to be the first sealing means.

FIG. 5 shows an alternative to the embodiment in FIG. 4. Contrary to FIG. 4 the sealing plug 19 only comprises lips 21 resting on the tire side surface of the crosswalls 7.

Apart from purely mechanical attachment, the sealing plug 19 may for example be additionally fastened to the surfaces of the crosswalls 7 by means of an adhesive. The sealing plug 19 illustrated both in FIG. 4 and FIG. 5 is additionally held in the rim 6 by the interior tire pressure. Preferably the sealing effect of the sealing plug 19 is increased for example by additionally mounting the rim tape 8 onto the tire side surfaces of the crosswalls 7 and the sealing plug 19.

The sealing plug 19 consists of rubber or another airtight material which fits snugly on the crosswalls 7.

Not shown in the FIGS. 1 to 5 is the sealing medium for sealing leakages. The sealing medium comprises a carrier liquid containing rubber latex and other substances. The liquid for sealing off a wheel has in particular a viscosity of 0.01 Pas to 0.40 Pas so as to ensure that the liquid disperses evenly and remains in motion so as to immediately seal even the tiniest leakages.

The carrier liquid of the sealing medium is for example water and may typically contain antifreeze agents, emulsifiers or other additives. The emulsifier serves above all to allow the sealing medium to readily wet the inner wheel surface.

Antifreeze agents enable the liquid to seal off leaks at the wheel even at low temperatures.

The sealing medium is preferably non-bonding. This means that the sealing medium preferably cures slowly or preferably causes weak adhesive bonding while still causing leakages or apertures to be sealed. Due to these properties of the sealing medium, a valve 17 through which the sealing medium is fed will not clog, thus remaining serviceable.

Preferably the sealing medium comprises rubber latex wherein the content of rubber latex in the sealing medium is approximately between 40 and 70 percent by weight, in particular 50 percent by weight. Rubber latex is the preferred means for sealing leakages. The use of rubber latex offers the advantage that the rubber latex can be washed out after treatment of the wheel. Therefore, fresh liquid can be added before the next use.

The liquid may further contain water, emulsifiers, typical antifreeze agents such as glycols or other additives.

Antifreeze agents enable the liquid to seal off at the wheel even at low temperatures.

Since the liquid cures slowly or preferably causes weak adhesive bonding to occur, it will thus over time seal leakages or apertures.

Approximately 60 to 70 grams of the sealing medium is fed into a wheel.

However, all of the sealing media available on the market can generally be used as a sealing medium for this device.

The device according to the invention can be used to seal off both tubeless wheels and wheels originally provided with a tube where the tube has been removed.

The combined use of the closure means to close the aperture 22 in the rim 6, such as the sealing plug 19, the valve 17 with sealing lip 11 as well as the sealing medium, results in good sealing of the wheel. The sealing medium, as for example in the case of the embodiment according to FIG. 2, is then substantially on the inner tire surface, on the sealing lip 11, between sealing lip 11 and rim tape 8 and between rim 6 and rim tape 8. If sealing plugs 19 according to FIGS. 4 and 5 are used, it can also seal off leakages between the sealing plugs 19 and the rim 6.

The individual components of the device such as the rim tape 8 or sealing plug 19 for closing the aperture 22, the valve 17 with sealing lip 11 and the sealing medium, do not necessarily have to be sold and/or mounted or applied together. This may be done separately. For example the valve 17 with the sealing lip 11 and sealing plug 19 can be bought separately and be attached to the wheel together.

A tubeless wheel is sealed as follows when using the device according to the invention. First the rim 6 is degreased, then the closing valve is attached to the rim 6 and the valve 17 is installed. Finally the sealing medium is fed into the interior of the wheel for example through the valve 17. For this purpose the valve is preferably configured in two pieces.

For closing apertures 22 of a rim 6 of a wheel one can use for example, only sealing plugs 19 or else the rim tape 8 and sealing plugs 19, or any desired combination of closure means.

It is also possible to refit a wheel comprising a tube by removing the tube and sealing the wheel by means of the device according to the invention. It has been shown that by means of the device according to the invention even such tires and rims can be sealed which were originally developed for use with tubes.

The wheels sealed with the device according to the invention are primarily used for two-wheeled vehicles such as mountain bikes.

Application of the device or of individual components is not limited to the type of rim illustrated in FIGS. 1 to 5. Other rim types such as U-shaped rims 6 without crosswalls 7 can also be sealed.

FIG. 6 is an illustration of a rim tape for the device according to the invention. This rim tape comprises a bottom middle surface 32 and two bottom side surfaces 34a and 34b. Additionally two upper side surfaces 36a and 36b are provided. The upper side surfaces 36a and 36b are also contact faces with the tubeless tire in the assembled state.

For this purpose the surfaces 36a and 36b can be structured, in particular but not exclusively ribbed, so as to increase the cohesive friction to the tire. The reference numerals 31a and 31b designate left- and right-side projections against which the tire rests. The projections 31a and 31b prevent the tire from gliding inwardly in FIG. 6. The surfaces 31a and 31b may also comprise structured surfaces such as ribbing so as to increase the cohesive friction with the tire.

The angle α of the projection 31a (as is the projection 31b) is between 20 degrees and 90 degrees, preferred between 30 degrees and 85 degrees and particularly preferred between 40 degrees and 80 degrees. In this way, an optimum form-fit with the tire can be achieved.

The reference numeral R2 designates the radius of curvature at the transition from the bottom portion and the projection 31b. The radius of curvature is, depending on the width of the rim, between 0.2 mm and 5 mm, preferred between 0.3 mm and 4 mm and particularly preferred between 0.5 mm and 3 mm. This radius of curvature is necessary for allowing the tubeless tire to pass over the projections 31a and 31b with a minimum of force applied. The radius of curvature R3 on the tip of the projection 31b is preferably at least 1 mm so as to allow dismantling of the tube of the tire with a minimum of force applied.

The outer radius of curvature R4 is between 0.2 mm and 0.9 mm, preferably between 0.3 mm and 0.7 mm and particularly preferred in the range of 0.5 mm so as to position the rim tape well—meaning as accurately as possible in the middle of the rim.

The radius of curvature R5 on the bottom surface of the rim tape serves for the same purpose.

The radius of curvature R6 in this embodiment serves for mounting and dismantling the tubeless tire with a minimum of force applied.

The radius of curvature R7 at the bottom of the rim tape is at least 1 mm, preferably at least 1.5 mm and particularly preferred at least 2 mm so as to prohibit the rim tape from canting on the rim while mounting the rim tape.

The bottom surface 37 preferably has a width of at least 2 mm, preferably at least 4 mm and particularly preferred of at least 6.5 mm. In this way the valve can be placed optimally and is secured against twisting substantially without play.

The tubeless tire is positioned, as specified above, between the projections 31a and 31b on the one hand and the respective left-side and right-side outer ends of the rim tape which is adjacent to the rim flange 1 shown in FIG. 1.

1. A wheel for a bicycle comprising: a rim body suitable for receiving a tubeless tire, a valve for inflating the tire with air, at least one first sealing means positioned on the rim body for sealing at least one aperture provided in the rim, and a sealing medium for sealing leakages, wherein the valve includes at least one second sealing means to seal off the valve relative to the rim.

2. The wheel according to claim 1, wherein the at least one first sealing means is a tape placed at the rim body.

3. The wheel according to claim 1, wherein the at least one first sealing means is made of a material containing TPU.

4. The wheel according to claim 1, wherein the at least one first sealing means comprises at least one surface having adhesive properties.

5. The wheel according to claim 1, wherein the at least one first sealing means comprises an adhesive tape.

6. The wheel according to claim 1, wherein the at least one first sealing means comprises at least one aperture.

7. The wheel according to claim 6, wherein the at least one aperture of the sealing means has an elliptical cross-section before being mounted to the rim body, wherein the long diameter of said cross-section is substantially transverse relative to the rim body.

8. The wheel according to claim 1, wherein the at least one first sealing means comprises at least one structured surface.

9. The wheel according to claim 5, wherein the adhesive tape comprises an adhesive containing acrylate.

10. The wheel according to claim 5, wherein the adhesive tape comprises polyester.

11. The wheel according to claim 5, wherein the adhesive tape is arranged to overlap in the region of the valve.

12. The wheel according to claim 1, wherein the valve comprises an unscrewable valve insert.

13. The wheel according claim 1, wherein at least one closure means for the apertures is provided.

14. The wheel according to claim 1, wherein the at least one second sealing means is made of a flexible material.

15. The wheel according to claim 1, wherein the at least one second sealing means is positioned at a shaft of the valve in a sealing manner.

16. The wheel according to claim 1, wherein the at least one second sealing means is positioned at a predetermined end portion of the valve.

17. The wheel according to claim 1, wherein the at least one second sealing means is a substantially planar foil.

18. A sealing medium for a wheel in particular according to claim 1, wherein the sealing medium contains components selected from a group of components including water, rubber latex, antifreeze agents and emulsifiers.

19. The sealing medium according to claim 18, wherein that the sealing medium is a liquid whose carrier liquid is water.

20. The sealing medium according to claim 18, wherein the sealing means exhibits substantially weak bonding properties.

21. The sealing medium according to claim 18, wherein the sealing means exhibits a viscosity of Pas 0.01 to Pas 0.40, measured at a temperature of 23° C. in the measuring system according to ISO 3219 at a shear rate of D=400 l/s.

22. The sealing medium according to at least claim 18, wherein the sealing means comprises a content of dry substance of more than 30%, preferably more than 45% and particularly preferably more than 50%.

23. A sealing device for wheels comprising: at least one first sealing means positioned at a rim body of the wheel for sealing at least one aperture provided in the rim, and a sealing medium for sealing leakages, wherein a valve of the wheel comprises at least one second sealing means for sealing the valve relative to the rim.

24. A method for manufacturing a wheel including the following process steps:
providing a rim for the wheel wherein the rim comprises at least one aperture;
applying at least one first sealing means to the rim;
placing a valve in the rim;
introducing at least one sealing medium for preventing leakages.

25. The method according to claim 24, wherein a second sealing means is placed at the valve.

26. The method according to claim 24, wherein in a further process step a tubeless tire is attached to the rim.

27. The method according to claim 24, wherein the sealing medium is fed into the wheel through the valve.

28. The method according to claim 24, wherein the first sealing means is applied to the rim at a predetermined prestress.
